(19) United States
(12) Patent Application Publication
(10) Pub. No.: US 2018/0219356 A1
(43) Pub. Date: Aug. 2, 2018

(54) IGNITION PLUG FOR INTERNAL COMBUSTION ENGINE

(71) Applicant: In Tae JUNG, Gyeonggi-do (KR)

(72) Inventor: In Tae JUNG, Gyeonggi-do (KR)

(21) Appl. No.: 15/748,216

(22) PCT Filed: Oct. 27, 2016
(86) PCT No.: PCT/KR2016/012121

§ 371 Date: Jan. 29, 2018

(30) Foreign Application Priority Data
Oct. 29, 2015 (KR) 10-2015-0151255

(51) Int. Cl. H01T 13/20; H01T 13/54

(52) U.S. Cl. CPC H01T 13/20; H01T 13/54

(57) ABSTRACT

An ignition plug for an internal combustion engine including: a main cell having a groove; an auxiliary cell which is formed on the outer circumferential surface of the main cell in a ring shape, surrounds the main cell and has a screw part formed on the outer face of the lower portion, the auxiliary cell having a bending part of which the upper portion is bent in the direction of the main cell and caught to the groove; a ring cover fit in the bending part; a first combustion chamber formed inside the lower portion of the auxiliary cell and in which an electrode for generating flames is accommodated; and an orifice valve combined to an end portion of the auxiliary cell to surround the electrode, the orifice valve having a protruding in the inward direction of the auxiliary cell and having at least one jet hole.

### BACKGROUND

The present invention relates to an ignition plug for an internal combustion engine, and more particularly, to an ignition plug for an internal combustion engine with an improved and stabilized structure which can prevent natural ignition inside the plug and enhance burning efficiency.

In order to obtain burning efficiency of optimal output required in a high-performance internal combustion engine which uses gasoline of a high-octane number, when the speed of revolution of the internal combustion engine is low, ignition is set at (±)5 degrees to (±)6 degrees before top dead center (BTDC), and as the speed of each engine increases, advance ignition is set at (±)50 degrees BTDC to obtain the maximum output of the engine.

A conventional ignition plug for an internal combustion engine is disclosed in Korean Patent No. 328490, As illustrated in FIG. 1, a part of a compressed fuel-air mixer of the internal combustion engine is primarily fired and burnt at the time of igniting of the electric igniting type internal combustion engine, and then small-scale explosive flames generated from the primary firing and burning are discharged into a combustion chamber, accordingly, a main fuel-air mixture in the combustion chamber is fired more quickly and reliably, and burnt within a relatively much shorter time. As a result, the whole burning time of the fuel-air mixture on the crankshaft angle can be shortened at maximum.

This type of the ignition plug has a single circular exhaust nozzle through which a fluid goes in and out. However, in comparison with the existing ignition plug, the burning time of the engine can be shortened but small-scale explosive flames may be transferred to the combustion chamber.

### SUMMARY OF THE INVENTION

Accordingly, the present invention has been made in view of the above-mentioned problems occurring in the prior art, and it is an object of the present invention to provide an ignition plug for an internal combustion engine with an improved structure which can overcome limits of the conventional ignition plug and can ignite in retard and short on a crankshaft at low speed and high speed to make the combustion speed of the whole engine fast up to an end portion of a main combustion chamber.

To accomplish the above object, according to the present invention, there is provided an ignition plug for an internal combustion engine including: a main cell having a groove formed at a predetermined position; an auxiliary cell which is formed on the outer circumferential surface of the main cell in a ring shape, surrounds the main cell and has a screw part formed on the outer face of the lower portion, the auxiliary cell having a bending part of which the upper portion is bent in the direction of the main cell 110 and caught to the grove; a ring cover fit in the bending part; a first combusting chamber which is formed inside the lower portion of the auxiliary cell and in which an electrode for generating flames is accommodated; and an orifice valve combined to an end portion of the auxiliary cell to surround the electrode, the orifice valve having a protruding in the inward direction of the auxiliary cell and having at least one jet hole.

Moreover, the orifice valve includes: one main jet hole formed at the central portion thereof; and at least one auxiliary jet hole formed in the circumferential direction of the main jet hole.

Furthermore, a guide part which has a predetermined curvature in all direction at 360 degrees is formed at an inner end of the auxiliary jet hole and has a continuous side including an outer end of the auxiliary jet hole.

Additionally, a diameter (D₂) of the inner end of the auxiliary jet hole is larger than a diameter (D₁) of the outer end of the auxiliary jet hole (D₂>D₁).

In addition, the ring cover is made of copper, heat-resistant aluminum alloy, fine silver, silver-copper alloy or iron.

Moreover, the electrode includes: a central electrode which is mounted in a straight line along a vertical direction from the central portion of the main cell and is exposed to the outside; and a pair of earth electrodes which are formed inside the lower portion of the auxiliary cell in an arc shape around the central electrode.

Furthermore, a heat-exchange member is interposed between the main cell and the auxiliary cell in order to exchange heat caused by flames and prevent leakage of volatile gas at the time of ignition by central electrode and the earth electrodes.

Additionally, two ignition plugs for the internal combustion engine are mounted in one main combustion chamber in order to make flame propagation speed fast.

As described above, the ignition plug for the internal combustion engine according to the present invention can make retarded ignition possible because the explosive flames through the first combustion chamber are spread and discharged to the inside of the main combustion chamber more rapidly due to the guide part formed inside the orifice valve of the plug, thereby obtaining increase of fuel efficiency and reduction of exhaust gas by enhancing ignition performance and ignition efficiency.

To accomplish the above object, according to the present invention, there is provided an ignition plug for an internal combustion engine including: a main cell having a groove formed at a predetermined position; an auxiliary cell which is formed on the outer circumferential surface of the main cell in a ring shape, surrounds the main cell and has a screw part formed on the outer face of the lower portion, the auxiliary cell having a bending part of which the upper portion is bent in the direction of the main cell 110 and caught to the groove; a ring cover fit in the bending part; a first combustion chamber which is formed inside the lower portion of the auxiliary cell and in which an electrode for generating flames is accommodated; and an orifice valve combined to an end portion of the auxiliary cell to surround the electrode, the orifice valve having a protruding in the inward direction of the auxiliary cell and having at least one jet hole.

Moreover, the orifice valve includes: one main jet hole formed at the central portion thereof; and at least one auxiliary jet hole formed in the circumferential direction the main jet hole.

Furthermore, a guide part which has a predetermined curvature in all direction at 360 degrees is formed at an inner end of the auxiliary jet hole and has a continuous side including an outer end of the auxiliary jet hole.

Additionally, a diameter (D₂) of the inner end of the auxiliary jet hole is larger than a diameter (D₁) of the outer end of the auxiliary jet hole (D₂>D₁).

In addition, the ring cover is made of copper, heat-resistant aluminum alloy, fine silver, silver-copper alloy or iron.

Moreover, the electrode includes: a central electrode which is mounted in a straight line along a vertical direction from the central portion of the main cell and is exposed to the outside; and a pair of earth electrodes which are formed inside the lower portion of the auxiliary cell in an arc shape around the central electrode.

Furthermore, a heat-exchange member is interposed between the main cell and the auxiliary cell in order to exchange heat caused by flames and prevent leakage of volatile gas at the time of ignition by the central electrode and the earth electrodes.

Additionally, two ignition plugs for the internal combustion engine are mounted in one main combustion chamber in order to make flame propagation speed fast.

As described above, the ignition plug for the internal combustion engine according to the present invention can make retarded ignition possible because the explosive flames through the first combustion chamber are spread and discharged to the inside of the main combustion chamber more rapidly due to the guide part formed inside the orifice valve of the plug, thereby obtaining increase of fuel efficiency and reduction of exhaust gas by enhancing ignition performance and ignition efficiency.

### BRIEF DESCRIPTION OF DRAWINGS

FIG. 1 is a front view of an ignition plug disclosed in Korean Patent No. 328490 and invented by the same inventor as the present invention.

FIG. 2 is a front view of an ignition plug for an internal combustion engine according to the present invention.

FIG. 3 is a sectional view of the ignition plug for the internal combustion engine according to the present invention.

FIG. 4 is an enlarged view showing an “A” part of FIG. 3.

FIG. 5 is an enlarged view showing an “A” part of FIG. 3.

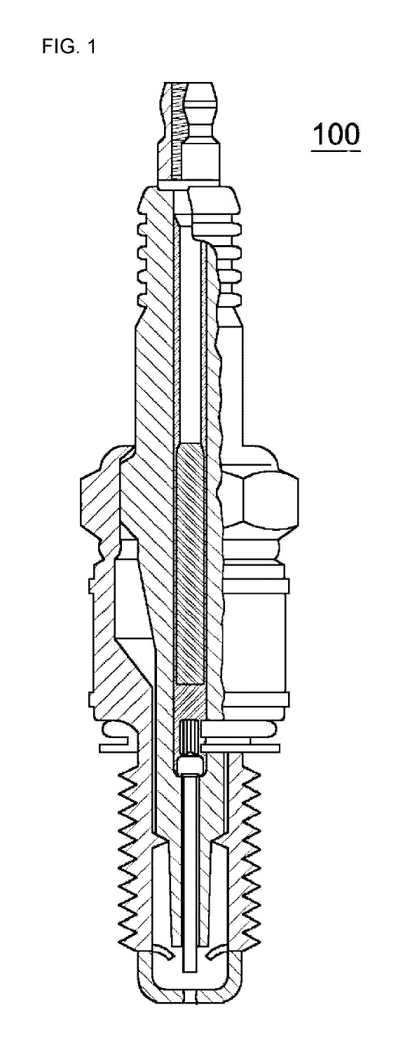

### DETAILED DESCRIPTION OF THE INVENTION

Advantages and features of the present invention, and method to achieve them of the present invention will be obvious with reference to embodiments along with the accompanying drawings which are described below. Meanwhile, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, an ignition plug for an internal combustion engine according to a preferred embodiment of the present invention will be described in detail with reference to the attached drawings.

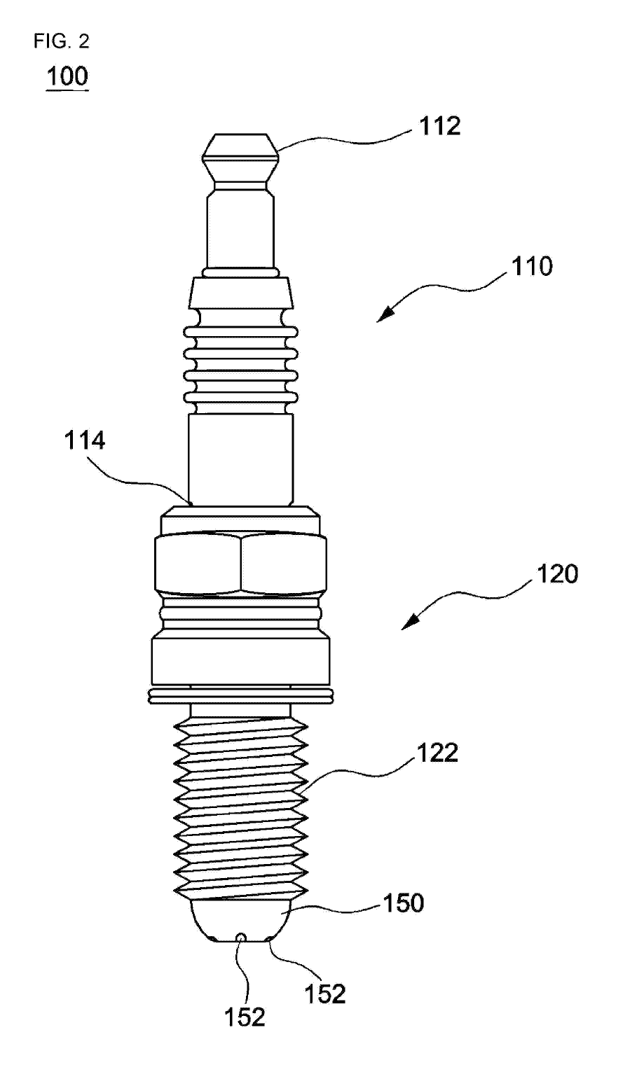

FIG. 2 is a front view of an ignition plug for an internal combustion engine according to the present invention.

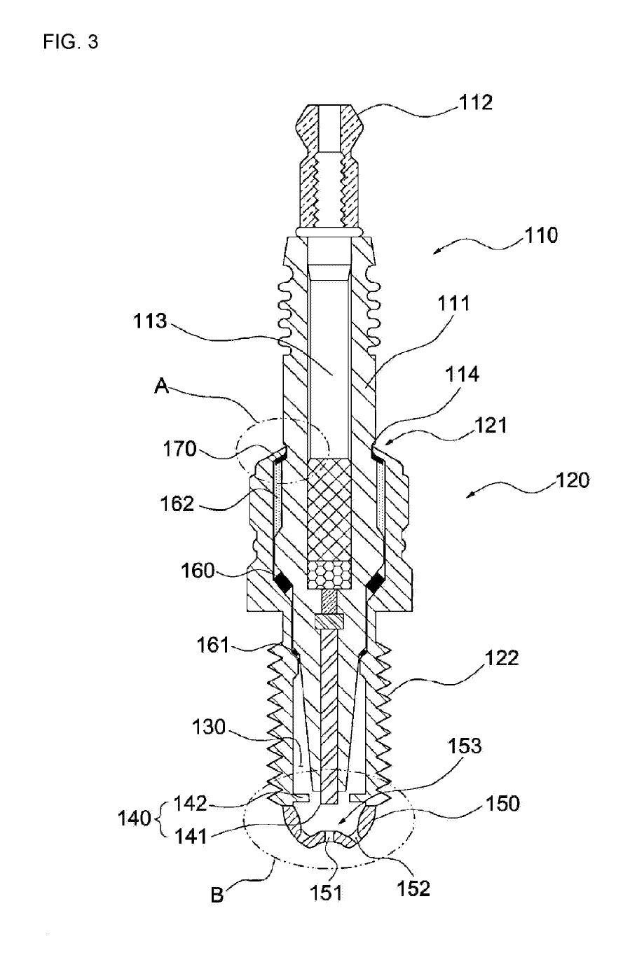

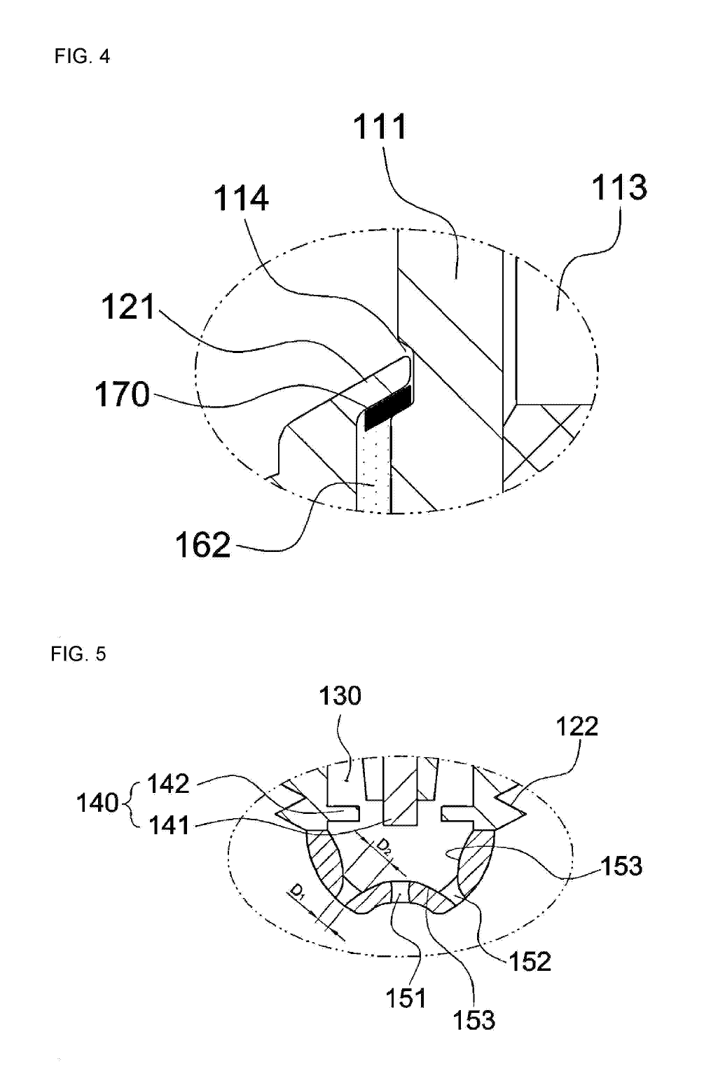

FIG. 3 is a sectional view of the ignition plug for the internal combustion engine according to the present invention, FIG. 4 is an enlarged view showing an “A” part of FIG. 3, and FIG. 5 is an enlarged view showing an “A” part of FIG. 3.

As shown in FIGS. 2 and 3, the ignition plug 100 for the internal combustion engine include a main cell 110 having a groove 114 formed at a predetermined position and an auxiliary cell 120 having a screw part formed on the outer face of a lower portion.

The groove 114 is formed on the outer circumferential surface of the main cell 110 in a ring shape, a central electrode 141 is mounted at the main cell 110 of a hollow type in a straight line along a vertical direction from the central portion and exposed to the outside. An insulator 111 is mounted in the hollow part of the main cell 110, and the insulator 111 is mounted on the main cell 110 in a state where the insulator 111 insulatedly coats the central electrode 141, and integrally coats a shaft seal 113 connected to an upper terminal 112 and the central electrode 141.

The auxiliary cell 120 surrounds the main cell 110 and includes a bending part 121 of which the upper portion is bent in direction of the main cell 110 and caught to the groove 114.

Moreover, a ring cover 170 fit in the bending part 121.

Alumina (Al₂O₃) or silicon dioxide mixture (SiO₂) 162 fill between the main cell 110 and the auxiliary cell 120.

Therefore, the ignition plug 100 for the internal combustion engine can have a more stable structure by preventing the auxiliary cell 120 from being separated from the main cell 110.

Furthermore, a first combustion chamber 130 is formed in such a way that an electrode 140 for generating flames is disposed inside a lower portion of the auxiliary cell 120 and an orifice valve 150 is combined to an end portion of the auxiliary cell to surround the electrode 140.

Due to such a structure, fuel-gas mixture of a main combustion chamber (not shown) inhaled in an intake stroke is compressed in a compression stroke, and at the same time some of the fuel-gas mixture pushed and ascending by a piston is accommodated in the first combustion chamber 130.

Additionally, the electrode 140 has different polarities by a power supply. The electrode 140 includes: the central electrode 141 which is mounted in the straight line along the vertical direction from the central portion of the main cell 110 and is exposed to the outside; and a pair of earth electrodes 142 which are formed inside the lower portion of the auxiliary cell 120 in an arc shape around the central electrode 141.

The central electrode 141 is formed in the straight line along the vertical direction, but the earth electrodes 142 are arranged in such a way that end portions thereof are adjacent to the central electrode 141.

Because the earth electrodes 142 are formed inside the lower portion of the auxiliary cell 120, the earth electrodes 142 realize a cooling action at an early stage so as to achieve electrification with respect to the central electrode 141 more effectively.

In addition, the orifice valve which may be called a cross flame valve 150 can be integrally formed with the auxiliary cell 120 by extending the circumferential portion of the auxiliary cell 120 or may be separately fabricated from the auxiliary cell 120 and combined with the auxiliary 120 so as to be assembled and disassembled with and from the auxiliary cell 120.

However, when the orifice valve 150 is separately fabricated from the auxiliary cell 120 and combined with the auxiliary cell 120, air tightness and assembly reliability with respect to the main cell 110 should be assumed taking the high pressure in the combustion chamber into consideration, and preferably, the orifice valve 150 is combined with the auxiliary cell 120 by laser welding.

The orifice valve 150 has at least one jet hole and the central portion of the orifice valve 150 protrudes in the inward direction of the auxiliary cell 120.

The orifice valve 150 includes one main jet hole 151 formed at the central portion thereof and at least one auxiliary jet hole 152 formed in the circumferential direction of the main jet hole 151.

The orifice valve 150 may be made of a heat-resistant and acid-resistant steel material, it is preferable that the orifice valve 150 have heat-exchange capacity to partially cool in other strokes except the expansion stroke of the four-stroke cycle engine, and it is good to adopt metal with small heat-absorption without being restricted by volume.

Because the ignition plug 100 mounted in the internal combustion engine may come into contact with or collide with the piston which vertically reciprocates under the orifice valve 150, the protrusion length of the lower portion of the orifice valve 150 must be controlled properly.

Moreover, a heat-exchange member is interposed between the main cell 110 and the auxiliary cell 120, and includes a first heat-exchange member 160 and a second heat-exchange member 161.

The first heat-exchange member 160, the second heat-exchange member 161 and the ring cover 170 form a heat sink so as to exchange high heat, which is generated by flames in the first combustion chamber 130, with the outside and prevent leakage of volatile gas at the time of ignition by the central electrode and the earth electrodes.

The first heat-exchange member 160, the second heat-exchange member 161 and the ring cover 170 may be made of metallic materials of various kinds, but preferably, the first heat-exchange member 160 and the ring cover 170 are made of copper, heat-resistant aluminum alloy, fine silver, silver-copper alloy or iron and the second heat-exchange member 161 is made of Inconel 600 or Inconel 601.

Therefore, the ignition plug 100 for the internal combustion engine is designed to have the optimal heat path to preventing natural ignition by keeping temperature inside the ignition plug 100.

FIG. 4 is an enlarged view of an “A” part of FIG. 3.

Referring to FIG. 4, the main cell 110 has the groove 114 formed at a predetermined position and the auxiliary cell 120 surrounds the main cell 110 and has a bending part 121 of which the upper portion is bent in direction of the main cell 100 and caught to the groove 114.

Moreover, the ring cover 170 fit in the bending part 121.

Alumina (Al₂o₃) or silicon dioxide mixture (SiO₂) 162 fill between the main cell 110 and the auxiliary cell 120.

Therefore, the ignition plug 100 for the internal combustion engine can have a more stable structure by preventing the auxiliary cell 120 from being separated from the main cell 110.

FIG. 5 is an enlarged view of a “B” part of FIG. 3.

Referring to FIG. 5, the first combustion chamber 130 in which the electrode 140 for generating flames is accommodated is formed inside the lower portion of the auxiliary cell 120, and the orifice valve 150 which has at least one jet hole is combined to the end portion of the auxiliary cell 120 to surround the electrode 140.

The central portion of the orifice valve 150 protrudes in the inward direction of the auxiliary cell 120, and the jet hole is formed therein.

The orifice valve 150 includes one main jet hole 151 formed at the central portion thereof and at least one auxiliary jet hole 152 formed in the circumferential direction of the main jet hole 151.

A guide part 153 having a predetermined curvature in all direction at 360 degrees is formed at an inner end of the auxiliary jet hole 152, and has a continuous side including an outer end of the auxiliary jet hole 152.

A diameter D₂ of the inner end of the auxiliary jet hole 152 is larger than a diameter D₁ of the outer end of the auxiliary jet hole 152 (D₂>D₁).

Then, when a combustion stroke reaches an igniting point of time, the electrodes 140 is electrified to thus generate an electrical spark, and such an electrical spark ignites and burns the fuel-gas mixture accommodated in the first combustion chamber 130.

When the fuel-gas mixture in the first combustion chamber 130 is burnt, the small-scale explosive flames are generated and fill the inside of the first combustion chamber 130. The pressure of the explosive flames in the first combustion chamber 130 is increased by the ascending piston within an extremely short time.

At a point of time when the pressure of the first combustion chamber 130 gets higher than that of the main combustion chamber, the small-scale explosive flames in the first combustion chamber 130 are discharged toward the main combustion chamber through the main jet hole 151 and the auxiliary jet hole 152.

The explosive flames discharged toward the main combustion chamber through the auxiliary jet hole 152 can come into or go out of the first combustion chamber 130 more smoothly along the smoothly curved surface formed on the circumference of the main jet hole.

Therefore, the explosive flames are discharged to the inside of the main combustion chamber while rapidly spreading from the outer surface of the orifice valve 150 in the radial direction on the plane, so that the ignition plug according to the present invention can rapidly ignite and burn the fuel-gas mixture compressed in the main combustion chamber to enable the combustion speed to be quick and ignite whole engine in retard and short.

Compared with the conventional ignition plug, the ignition plug 100 according to the present invention can cause quick and sure ignition since igniting in retard and short and can burn all within a short time.

Therefore, because ignition is generated in the combustion chamber smaller in volume than the combustion chamber in which the conventional ignition plug is mounted, the ignition plug according to the present invention can make ignition environment with fuel of a smaller quantity, thereby enhancing ignition efficiency and ignition performance.

Furthermore, two ignition plugs 100 according to the present invention may be mounted in one main combustion chamber. Compared whit the conventional ignition plug 100 that one ignition plug 100 is mounted in the main combustion chamber, when the two ignition plugs 100 is mounted in the main combustion chamber, the flame propagation speed gets faster.

Therefore, when the two ignition plugs 100 are mounted, because it can ignite in retard and short than the time when one ignition plug 100 is mounted, the ignition plug according to the present invention can make ignition sure and ignite in less time than the conventional ignition plug.

Accordingly, because ignition is generated in the combustion chamber smaller in volume than the combustion chamber in which one ignition plug is mounted, the ignition plug according to the present invention can make burning environment with fuel of a smaller quantity, thereby enhancing ignition efficiency and ignition performance.

Those skilled in the art will understand that the present invention can be implemented as other concrete forms without changing the inventive concept or essential features. Therefore, these embodiments as described above are only proposed for illustrative purposes and do not limit the present invention. It will be apparent to those skilled in the art that a variety of modifications and variations may be made without departing the spirit and scope of the present invention as defined by the appended claims. Further, such modifications and variations should not be understood independently from the technical idea or perspective of the present invention.

### EXPLANATION OF REFERENCE NUMERALS IN DRAWINGS

| | |
|---|---|
| 100: Ignition plug | 110: main cell |
| 111: Insulator | 112: Terminal |
| 113: Shaft seal | 114: Groove |
| 120: Auxiliary cell | 121: Bending part |
| 122: Screw part | 130: First combustion chamber |
| 140: Electrode | 141: Central electrode |
| 142: Earth electrode | 150: Orifice valve |
| 151: Main jet hole | 152: Auxiliary jet hole |
| 153: Guide part | 160: First heat-exchange member |

161: Second heat-exchange member
162: Alumina (Al₂o₃) or silicon dioxide mixture (SiO₂)
170: Ring cover

1. An ignition plug for an internal combustion engine comprising:
a main cell having a groove formed at a predetermined position;
an auxiliary cell which is formed on the outer circumferential surface of the main cell in a ring shape, surrounds the main cell and has a screw part formed on the outer face of the lower portion, the auxiliary cell having a bending part of which the upper portion is bent in the direction of the main cell and caught to the groove;
a ring cover fit in the bending part;
a first combustion chamber which is formed inside the lower portion of the auxiliary cell and in which an electrode for generating flames is accommodated; and
an orifice valve combined to an end portion of the auxiliary cell to surround the electrode, the orifice valve having a protruding in the inward direction of the auxiliary cell and having at least one jet hole.

2. The ignition plug according to claim 1, wherein the orifice valve comprises: one main jet hole formed at the central portion thereof; and at least one auxiliary jet hole formed in the circumferential direction of the main jet hole.

3. The ignition plug according to claim 2, wherein a guide part which has a predetermined curvature in all direction at 360 degrees is formed at an inner end of the auxiliary jet hole and has a continuous side including an outer end of the auxiliary jet hole.

4. The ignition plug according to claim 3, wherein a diameter (D₂) of the inner end of the auxiliary jet hole is larger than a diameter (D₁) of the outer end of the auxiliary jet hole (D₂>D₁).

5. The ignition plug according to claim 1, wherein the ring cover is made of copper, heat-resistant aluminum alloy, fine silver, silver-copper alloy iron.

6. The ignition plug according to claim 1, wherein the electrode comprises: a central electrode which is mounted in a straight line along a vertical direction from the central portion of the main cell and is exposed to the outside; and a pair off earth electrodes which are formed inside the lower portion of the auxiliary cell in an arc shape around the central electrode.

7. The ignition plug according to claim 1, wherein a heat-exchange member is interposed between the main cell and the auxiliary cell in order to exchange heat caused by flames and prevent leakage of volatile gas at the time of ignition by the central electrode and the earth electrodes.

8. The ignition plug according to claim 1, wherein two ignition plugs for the internal combustion engine are mounted in one main combustion chamber in order to make flame propagation speed fast.
